(19) United States
(12) Patent Application Publication
(10) Pub. No.: US 2004/0139823 A1
(43) Pub. Date: Jul. 22, 2004

(54) Biasing arrangement for a pawl of a reversible ratchet-type wrench

(76) Inventor: Bobby Hu, Taichung (TW)

Correspondence Address: CONLEY ROSE, P.C., P. O. BOX 3267, HOUSTON, TX, 77253-3267, US

(21) Appl. No.: 10/751,722

(22) Filed: Jan. 5, 2004

Related U.S. Application Data
(63) Continuation of application No. 09/942,061, filed on Aug. 29, 2001.
Application No. 09/942,061 is a continuation of application No. 09/541,193, filed on Apr. 3, 2000, now Pat. No. 6,282,992.

(30) Foreign Application Priority Data
Feb. 3, 2000 (TW) 89202280

(51) Int. Cl. B25B 13/46

(52) U.S. Cl. 81/63.1

(57) ABSTRACT

A reversible ratchet-type wrench includes a handle and a head extended from the handle and having a hole. A web is defined between the handle and the head, and a cavity is defined in the web and communicated with the hole. The web further includes a compartment having a first end communicated with the cavity and a second end communicated with outside, thereby leaving a bridge in the web. A drive member is rotatably mounted in the hole of the head. A pawl is mounted in the cavity and includes a first side with ratchet teeth for releasably engaging with teeth on an outer periphery of the drive member. A switch member includes a turn-piece for manual operation and an actuating plate extended from the turn-piece and rotatably received in the second end of the compartment of the head. The switch member is switchable between two positions for changing ratcheting direction of the drive member. A biasing arrangement is mounted in the cavity and between the pawl and the actuating plate for biasing the ratchet teeth of the pawl to engage with the teeth of the drive member.

### CROSS-REFERENCE TO RELATED APPLICATIONS

This application is a continuation of U.S. application Ser. No. 09/942,061, filed Aug. 29, 2001 and still pending, which is a continuation application of U.S. application Ser. No. 09/541,193 filed Apr. 3, 2000, now U.S. Pat. No. 6,282,992. Both U.S. application Ser. No. 09/942,061 and U.S. Pat. No. 6,282,992 are hereby incorporated by reference in their entirety.

### BACKGROUND OF THE INVENTION

1. Field of the Invention

The present invention relates to a biasing arrangement for a pawl of a reversible ratchet type wrench to provide reliable ratcheting. The present invention also relates to an improved head structure for a ratchet-type wrench to lower the manufacture cost.

2. Description of the Related Art

U.S. Pat. No. 2,957,377 issued to Hare on Oct. 25, 1960 discloses a reversible ratchet type wrench comprising a body 10 having a handle 11 and a head 12. A cap 39 and an annular wall 44 are provided to upper side and lower side of the head 12, respectively. Yet, this increases the assembly time and the manufacture cost and adversely affects the appearance. A shifting lever 35 is retained in place by a spring 33 that is located in a cylindrical opening 34. Nevertheless, formation of the cylindrical opening 34 that extends inclined upward is relatively difficult. In addition, formation of the cavity 16 having converging straight sides 17, 18 which diverge in the direction of the periphery of rotatable member 14 requires expensive and accurate computer-numeric-control (CNC), which further results in an increase in the cost together with a low production rate. This is why such reversible ratchet type wrench is hardly seen in the market.

FIGS. 10 and 11 illustrate another conventional ratchet type wrench comprising a handle 12′ and a head 11′. The head 11′ is machined to form four consecutive compartments for receiving the drive member 20′, the pawl 30′ and the shifting lever 40′, wherein three of the compartments can be formed by cutting, yet the remaining one must be machined by CNC. Further, the resultant head structure is relatively weak and thus has a poor torque-bearing capacity. In addition, the movement of the pawl 30′ for changing ratcheting direction is found unreliable, as it is achieved via transmission of the hook end 442′ of a spring 44′ attached to the shifting lever 40′.

### SUMMARY OF THE INVENTION

In accordance with a first aspect of the invention, a reversible ratchet-type wrench comprises:

a handle;

a head extended from the handle and including a hole, a web being defined between the handle and the head, a cavity being defined in the web and communicated with the hole, the web further including a compartment having a first end communicated with the cavity and a second end communicated with outside, thereby leaving a bridge in the web;

a drive member rotatably mounted in the hole of the head, the drive member including a plurality of teeth formed on an outer periphery thereof;

a pawl mounted in the cavity and including a first side with a plurality of ratchet teeth for releasably engaging with the teeth of the drive member;

a switch member including a turn-piece for manual operation and an actuating plate extended from the turn-piece and rotatably received in the second end of the compartment of the web, the switch member being switchable between two positions for changing ratcheting direction of the drive member; and

a biasing means mounted in the cavity and between the pawl and the actuating plate for biasing the ratchet teeth of the pawl to engage with the teeth of the drive member.

An inner periphery defining the hole of the head includes a first annular groove. The outer periphery of the drive member includes a second annular groove. A C-clip is received in the first annular groove and the second annular groove, thereby rotatably retaining the drive member in the head.

The biasing means includes an elastic element and a peg. The pawl further includes a second side with a recess. The peg has a first end movably received in the recess of the pawl and a second end. The elastic element biases the second end of the peg for exerting a force to the peg toward the pawl, thereby urging the ratchet teeth of the pawl to engage with the teeth of the gear wheel.

In an embodiment of the invention, the actuating plate of the switch member includes a receptacle that faces the cavity. The elastic element includes a first end received in the receptacle and a second end outside the receptacle and configured to be attached to the actuating plate. The second end of the peg is received in the elastic element. The first end of the elastic element is configured to bias the second end of the peg toward the recess of the pawl.

In another embodiment of the invention, the actuating plate of the switch member includes a first receptacle that faces the cavity, the first receptacle having a first end wall. The second end of the peg is received in the first receptacle and includes a second receptacle with a second end wall. Two ends of the elastic element are attached between the first end wall and the second end wall.

The drive member may be a gear wheel including an inner periphery for driving a fastener. Alternatively, the drive member includes a drive column for releasably engaging with a socket. The head includes an end wall with an opening, and the drive member includes a stub rotatably received in the opening.

In accordance with a second aspect of the invention, a reversible ratchet-type wrench comprises:

a handle;

a head extended from the handle and including a hole, a web being defined between the handle and the head, a cavity being defined in the web and communicated with the hole, the web further including a compartment communicated with the cavity;

a drive member rotatably mounted in the hole of the head, the drive member including a plurality of teeth formed on an outer periphery thereof,

a pawl mounted in the cavity and including a first side with a plurality of ratchet teeth for releasably engaging with the teeth of the drive member, the pawl further including a second side with a recess;

a switch member including a turn-piece for manual operation and an actuating plate extended from the turn-piece and rotatably received in the compartment of the web, the switch member being switchable between two positions for changing ratcheting direction of the drive member; and

a biasing means mounted in the cavity and between the recess of the pawl and the actuating plate for biasing the ratchet teeth of the pawl to engage with the teeth of the drive member, the biasing means including an elastic element and a peg, the peg having a first end movably received in the recess of the pawl and a second end, the elastic element biasing the second end of the peg for exerting a force to the peg toward the pawl, thereby urging the ratchet teeth of the pawl to engage with the teeth of the gear wheel;

the actuating plate of the switch member including a receptacle that faces the cavity, the elastic element including a first end received in the receptacle and a second end outside the receptacle and configured to be attached to the actuating plate, the second end of the peg being received in the elastic element, the first end of the elastic element being configured to bias the second end of the peg toward the recess of the pawl.

In accordance with a third aspect of the invention, a reversible ratchet-type wrench comprises:

a handle;

a head extended from the handle and including a hole, a web being defined between the handle and the head, a cavity being defined in the web and communicated with the hole, the web further including a compartment communicated with the cavity;

a drive member rotatably mounted in the hole of the head, the drive member including a plurality of teeth formed on an outer periphery thereof;

a pawl mounted in the cavity and including a first side with a plurality of ratchet teeth for releasably engaging with the teeth of the drive member, the pawl further including a second side with a recess;

a switch member including a turn-piece for manual operation and an actuating plate extended from the turn-piece and rotatably received in the compartment of the web, the switch member being switchable between two positions for changing ratcheting direction of the drive member; and

a biasing means mounted in the cavity and between the recess of the pawl and the actuating plate for biasing the ratchet teeth of the pawl to engage with the teeth of the drive member, the biasing means including an elastic element and a peg, the peg having a first end movably received in the recess of the pawl and a second end, the elastic element biasing the second end of the peg for exerting a force to the peg toward the pawl, thereby urging the ratchet teeth of the pawl to engage with the teeth of the gear wheel;

the actuating plate of the switch member including a first receptacle that faces the cavity, the first receptacle having a first end wall, the second end of the peg being received in the first receptacle and including a second receptacle with a second end wall, the elastic element having two ends that are attached between the first end wall and the second end wall.

In accordance with a fourth aspect of the invention, a reversible ratchet-type wrench comprises:

a handle;

a head extended from the handle and including a hole, a web being defined between the handle and the head, a cavity being defined in the web and communicated with the hole, the web further including a compartment communicated with the cavity;

a drive member rotatably mounted in the hole of the head, the drive member including a plurality of teeth formed on an outer periphery thereof;

a pawl mounted in the cavity and including a first side with a plurality of ratchet teeth for releasably engaging with the teeth of the drive member, the pawl further including a second side with a recess;

a switch member rotatably received in the compartment of the web, the switch member being switchable between two positions for changing ratcheting direction of the drive member; and

a biasing means mounted in the cavity and having a first end slidably received in the recess of the pawl and a second end attached to the switch member for biasing the ratchet teeth of the pawl to engage with the teeth of the drive member.

Other objects, advantages, and novel features of the invention will become more apparent from the following detailed description when taken in conjunction with the accompanying drawings.

### BRIEF DESCRIPTION OF THE DRAWINGS

FIG. 1 is an exploded perspective view of an end portion of a first embodiment of a ratchet-type wrench in accordance with the present invention.

FIG. 2 is a sectional view of the end portion of the first embodiment of the ratchet-type wrench in accordance with the present invention.

FIG. 3 is a top view, partly sectioned, of the end portion of the first embodiment of the ratchet-type wrench in accordance with the present invention, wherein the wrench is in a status allowing counterclockwise ratcheting.

FIG. 4 is a view similar to FIG. 3, wherein the wrench is in a status allowing free rotation in both directions.

FIG. 5 is a view similar to FIG. 3, wherein the wrench is in a status allowing clockwise ratcheting.

FIG. 6 is a perspective view of the end portion of the first embodiment of the ratchet-type wrench in accordance with the present invention.

FIG. 7 is a sectional view illustrating a second embodiment of the ratchet-type wrench in accordance with the present invention.

FIG. 8 is a top view of an end portion of a third embodiment of the ratchet-type wrench in accordance with the present invention.

FIG. 9 is a sectional view illustrating a fourth embodiment of the ratchet-type wrench in accordance with the present invention.

FIG. 10 is an exploded perspective view of a conventional ratchet type wrench.

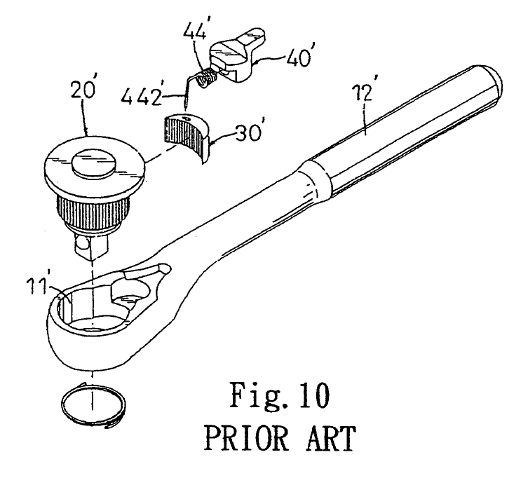

FIG. 11 is a sectional view of a head portion of the conventional ratchet type wrench in FIG. 10.

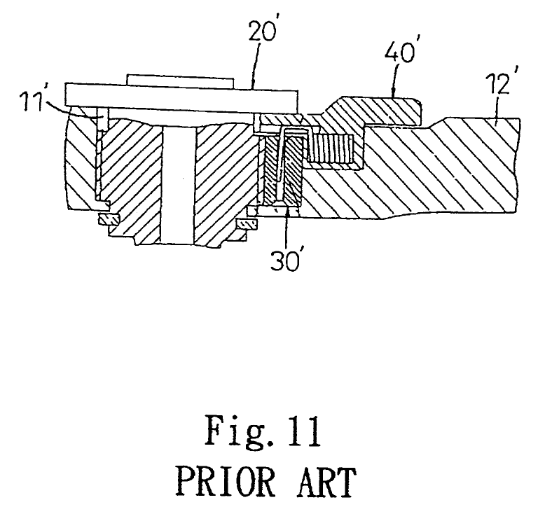

### DETAILED DESCRIPTION OF THE PREFERRED EMBODIMENTS

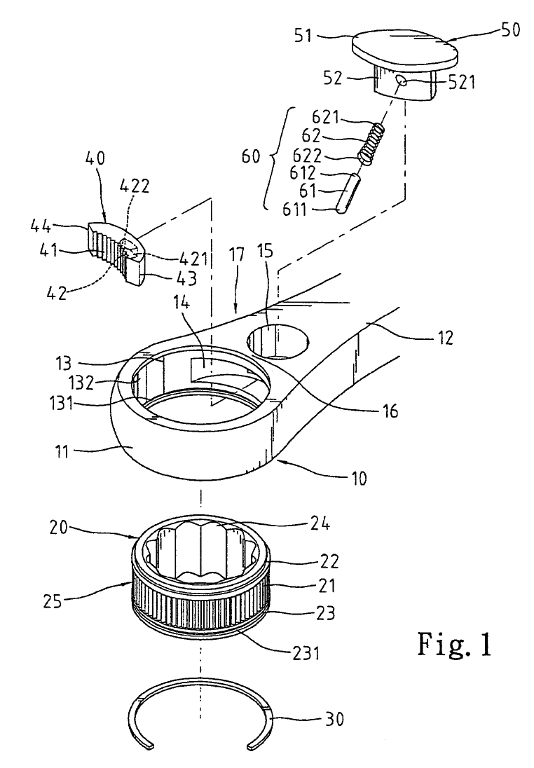

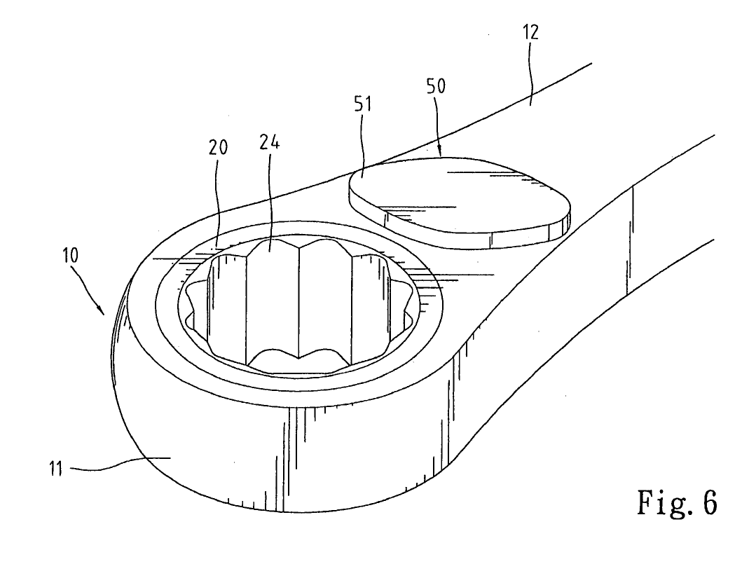

Referring to FIGS. 1 through 9 and initially to FIGS. 1, 2, 3, and 6, a ratchet-type wrench 10 in accordance with the present invention generally includes a handle 12 and a head 11 having a hole 13. An inner periphery 132 defining the hole 13 of the head 11 includes an annular groove 131 in a lower portion thereof. A web 17 is defined between the head 11 and the handle 12. A cavity 14 is defined in the web 17. Also defined in the web 17 is a compartment 15 that is substantially L-shape and includes an inner end communicated with the cavity 14 and an outer end communicated with outside, thereby leaving a bridge 16 on the web 17. The outer end of the compartment 15 is preferably circular. The bridge 16 increases the strength of the head 11 and the handle 12, thereby providing a higher torque-bearing capacity.

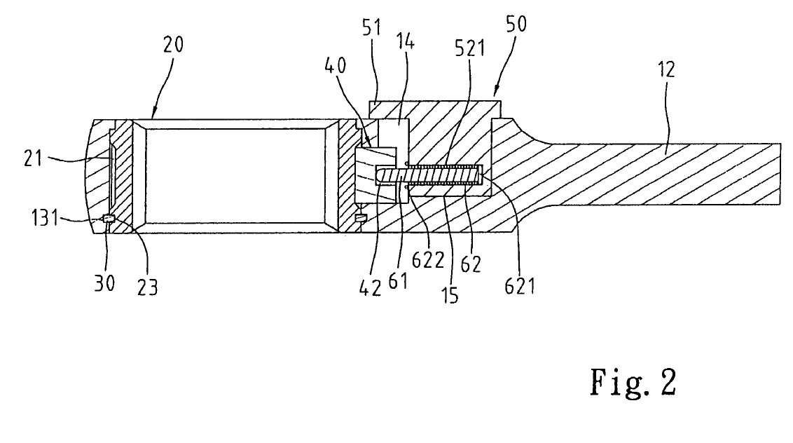

A drive member (in the form of a gear wheel 20 in this embodiment) is mounted in the head 11 and includes an inner periphery 24 for driving a fastener (not shown) and an outer periphery 25. The outer periphery 25 includes a recessed upper end portion 22, a lower end portion 23, and a middle portion with a plurality of recessed teeth 21. The lower end portion 23 includes an annular groove 231. A C-clip 30 is received in the annular groove 231 of the lower end portion 23 and the annular groove 131 of the head 13, thereby rotatably retaining the gear wheel 20 in the head 11 of the wrench 10, best shown in FIG. 2.

A pawl 40 is mounted in cavity 14 in the web 17 and includes ratchet teeth 41 on a side thereof for engaging with teeth 21 of the gear wheel 20. The other side of the pawl 40 further includes a recess 42 having two ends 421 and 422, which will be described later.

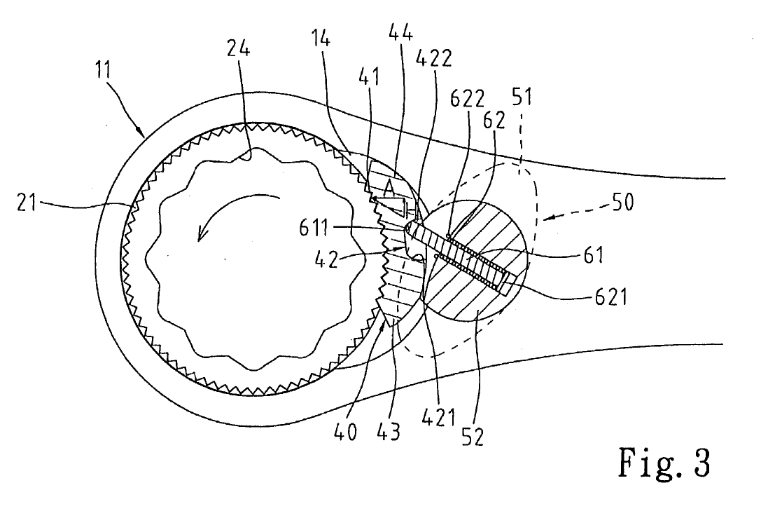

Still referring to FIGS. 1 through 3, a switch member 50 is rotatably mounted to the second end of the compartment 15. In this embodiment, the switch member 50 includes a turn-piece 51 outside the compartment 15 for manual operation and an actuating plate 52 extended from the turn-piece 51 and having a receptacle 521 that faces the cavity 14. A biasing means 60 is mounted in the receptacle 521 and includes an elastic element 62 and a peg 61. In this embodiment, as illustrated in FIG. 2, the elastic element 62 includes a first end 621 configured to bias an end 612 of the peg 61. A second end 622 of the elastic element 62 is configured to have a larger diameter so as to bear against and thus be attached to the actuating plate 52 in an area surrounding an opening section (not labeled) of the receptacle 521, as shown in FIG. 3.

In assembly, the switch member 50 is mounted in the compartment 15 and the biasing means 60 is mounted into the receptacle 521 of the switch member 50 via the cavity 14 with the elastic element 62 surrounding a part of the peg 61. The end 612 of the peg 61 bears against the first end 621 of the elastic element 62. The pawl 40 is mounted into the cavity 14 with the other end 612 of the peg 61 extended into the recess 42 of the pawl 40. The C-clip 30 is placed into the hole 132 and the gear wheel 20 is then mounted in the hole 132 with the C-clip 30 received in the annular grooves 131 and 231, thereby completing the assembly. Thus, the assembly procedure is simple and can be accomplished quickly by a C-clip 30 without the aid of any screw or cover.

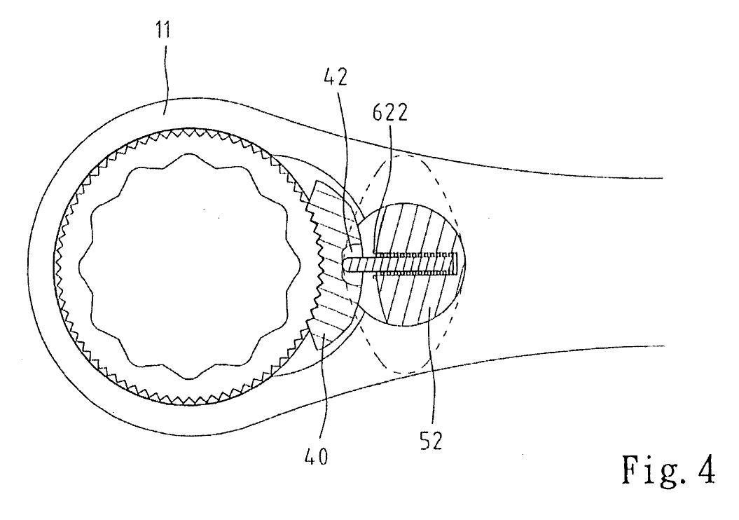

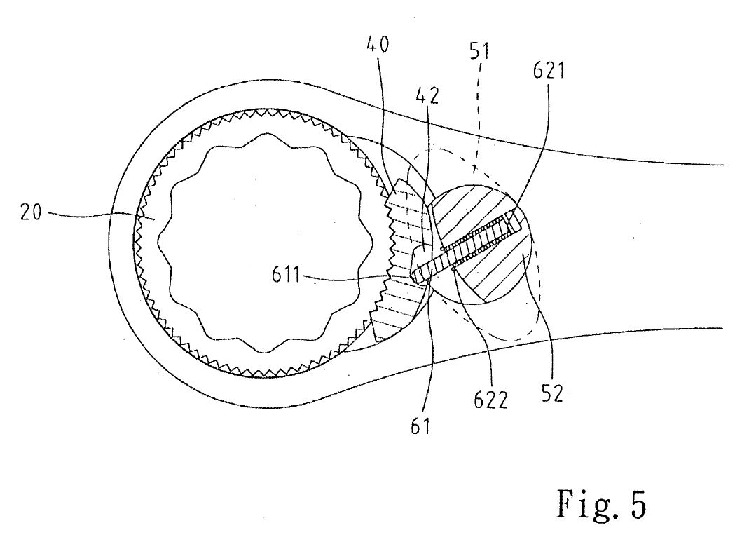

The ratchet-type wrench in FIG. 3 is in a status allowing counterclockwise ratcheting (free rotation in clockwise direction), in which the other end 611 of the peg 61 bears against an end 422 of the recess 42 of the pawl 40, and an end 44 of the pawl 40 bears against a wall portion defining the cavity 14. When a change in the ratcheting direction is required, the user may switch the turn-piece 51 and thus cause the biasing means 60 to move. FIG. 4 shows a transition position for the ratchet-type wrench that allows free rotation in both directions. As illustrated in FIG. 4, the elastic element 62 is stretched during rotational movement of the turn-piece. When the turn-piece 51 reaches its predetermined position shown in FIG. 5, the other end 611 of the peg 61 bears against the other end 421 of the recess 42 of the pawl 40, and the other end 43 of the pawl 40 bears against another wall portion defining the cavity 14. Thus, the ratchet-type wrench is in a status allowing clockwise ratcheting and free rotation in the counterclockwise direction.

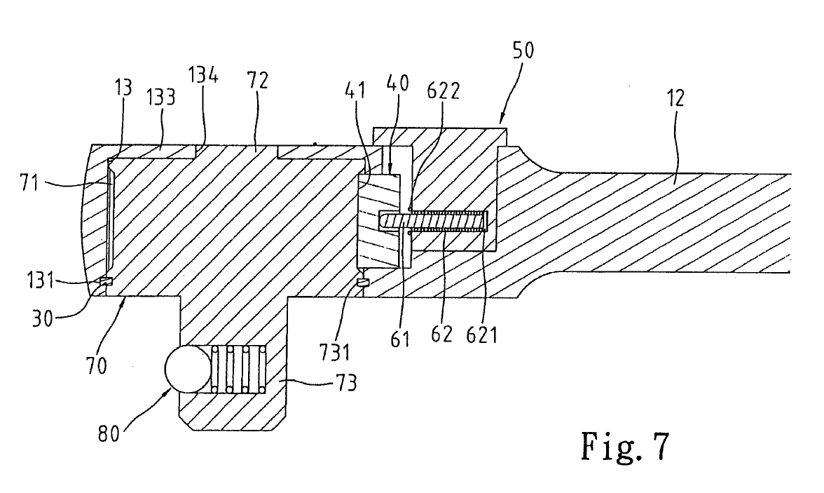

FIG. 7 illustrates a second embodiment in accordance with the present invention, wherein the gear wheel 20 is replaced by a drive member 70 having a drive column 73 with an engaging means 80 for releasably engaging with a socket (not shown). The drive member 70 includes an outer periphery having a plurality of teeth 71 for engaging with the pawl teeth 41. An annular groove 731 is defined in a lower portion of the outer periphery of the drive member 70 for engaging with the C-clip 30, which is identical to that disclosed above. In addition, the drive member 70 includes a stub 72 on a top thereof, and the upper portion of the head 11 is modified to include an end wall 133 with an opening 134 for rotatably receiving the stub 72 of the drive member 70, thereby providing stable rotational movement for the drive member 70.

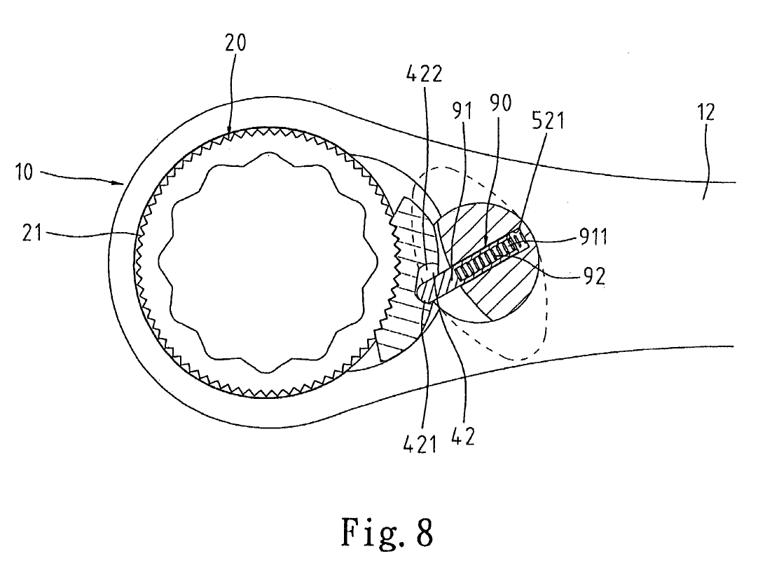

FIG. 8 illustrates a third embodiment in accordance with the present invention. It is noted that the biasing means (now designated by 90) in this embodiment includes a pin 92 that is having a receptacle 911 for receiving an end of the elastic element 92. Thus, the elastic element 92 is attached between an end wall (not labeled) defining the receptacle 911 of the pin 92 and an end wall (not labeled) defining the receptacle 521 of the switch member 50.

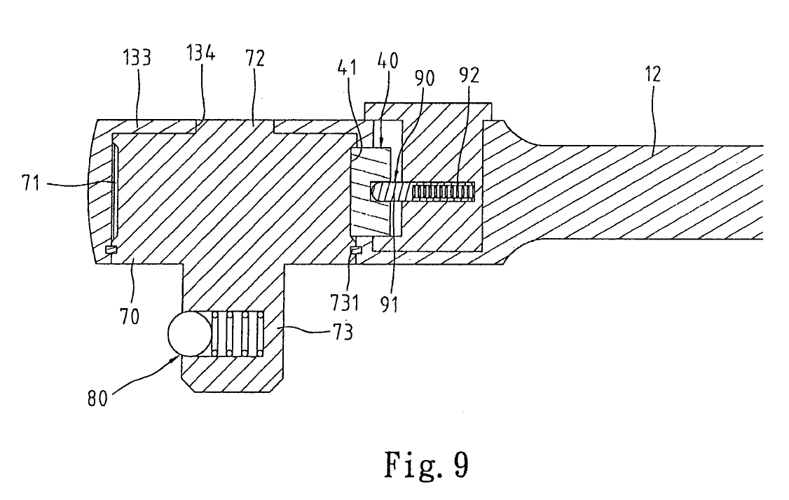

FIG. 9 illustrates a fourth embodiment in accordance with the present invention. It is noted that the biasing means 90 in the fourth embodiment is identical to that of the third embodiment, and the drive member 70 in the fourth embodiment is identical to that of the second embodiment.

Although the invention has been explained in relation to its preferred embodiment, it is to be understood that many other possible modifications and variations can be made without departing from the spirit and scope of the invention as hereinafter claimed.

What is claimed is:

1. A reversible ratchet-type wrench comprising:
a handle having a head extended from the handle and a web between said handle and the head; wherein the head has a hole in communication with a cavity in the web;
a compartment disposed in the web and having a first end in communication with the cavity and a second end in communication with an outside surface of the web; wherein a bridge is maintained in the web between the hole and said compartment;
a drive member rotatably mounted in the hole of the head, said drive member including a plurality of teeth formed on an outer periphery thereof;
a pawl mounted in the cavity and including a first side with a plurality of ratchet teeth and a second side with a recess;
a switch member including a turn-piece for manual operation and an actuating plate extended from the turn-piece and rotatably received in the second end of said compartment, wherein the actuating plate has a receptacle facing the recess in said pawl;
a biasing means engaged between the receptacle in said switch member and the recess in said pawl, said biasing means adapted to urge the ratchet teeth of said pawl into engagement with the teeth of said drive member; and
wherein said switch member has a first position where, upon counterclockwise rotation of said handle, said pawl engages said cavity and said drive member so as to prevent relative rotation between said drive member and said handle, and upon clockwise rotation of said handle, said pawl disengages said drive member and compresses said biasing means in a manner that urges said switching member to the first position.

2. The wrench of claim 1 wherein said switch member has a second position whereupon clockwise rotation of said handle, said pawl engages said cavity and said drive member so as to prevent relative rotation between said drive member and said handle, and upon counterclockwise rotation of said handle, said pawl disengages said drive member and compresses said biasing means in a manner that urges said switching member to the second position.

3. The wrench of claim 1 wherein said biasing means creates a clockwise torque about the center of rotation of the switch member when said handle is rotated in the counterclockwise direction, while said switch member is in the first position.

4. The wrench of claim 2 wherein said biasing means creates a counterclockwise torque about the center of rotation of the switch member when said handle is rotated in the clockwise direction, while said switch member is in the second position.

5. The wrench of claim 1 wherein said biasing means comprises an elongate member and an elastic member.

6. The wrench of claim 5 wherein the elastic member is at least partially disposed within the elongate member.

7. The wrench of claim 5 wherein the elongate member has a first end adapted to engage the recess in said pawl and a second end adapted to engage the receptacle in said switch member, wherein said pawl is adapted to rotate about the first end of said elongate member.

8. The wrench of claim 1 wherein the second side of said pawl is curved and is adapted to engage a curved wall of said cavity.

9. A reversible ratcheting mechanism comprising:
a housing having an upper face and a lower face with a circular hole extending from the upper face through the lower face, a circular compartment extending from the upper face, and a cavity connecting the circular compartment to the circular hole; wherein the axis of the circular hole is parallel to the axis of the circular compartment;
a drive member rotatably mounted in the circular hole, said drive member including a plurality of teeth formed on an outer periphery thereof;
a pawl mounted in the cavity, said pawl including a first side with a plurality of ratchet teeth and a second side with a recess, wherein the recess has a first end and a second end;
a switch member including a turn-piece for manual operation and an actuating plate extended from the turn-piece and rotatably received in the compartment, wherein the actuating plate has a receptacle facing the recess in said pawl;
a biasing means having an elongate member, with a first end extending into the cavity and engaging the recess of said pawl and a second end disposed within the receptacle of said switch member, and an elastic member adapted to urge the elongate member into the recess of said pawl such that the ratchet teeth of said pawl engage the teeth of said drive member;
said switch member being rotatably switchable between a first position and a second position; wherein the first position has a clockwise ratcheting direction and a counterclockwise free rotation direction and the second position has a counterclockwise ratcheting direction and a clockwise free rotation direction; and
wherein counterclockwise free rotation biases said switch member to the first position and clockwise free rotation biases said switch member to the second position.

10. The mechanism of claim 9 wherein said switch member has a second position whereupon clockwise rotation of said handle, said pawl engages said cavity and said drive member so as to prevent relative rotation between said drive member and said handle, and upon counterclockwise rotation of said handle, said pawl disengages said drive member and compresses said biasing means in a manner that urges said switching member to the second position.

11. The mechanism of claim 9 wherein said biasing means creates a clockwise torque about the center of rotation of the switch member when said handle is rotated in the counterclockwise direction, while said switch member is in the first position.

12. The mechanism of claim 10 wherein said biasing means creates a counterclockwise torque about the center of rotation of the switch member when said handle is rotated in the clockwise direction, while said switch member is in the second position.

13. The mechanism of claim 9 wherein said biasing means comprises an elongate member and an elastic member.

14. The mechanism of claim 13 wherein the elastic member is at least partially disposed within the elongate member.

15. The mechanism of claim 13 wherein the elongate member has a first end adapted to engage the recess in said pawl and a second end adapted to engage the receptacle in said switch member, wherein said pawl is adapted to rotate about the first end of said elongate member.

16. The mechanism of claim 9 wherein the second side of said pawl is curved and is adapted to engage a curved wall of said cavity.
